(19) United States
(12) Patent Application Publication
(10) Pub. No.: US 2008/0104177 A1
(43) Pub. Date: May 1, 2008

(54) METHOD TO FACILITATE SENDER NOTIFICATION OF OUT-OF-OFFICE STATUS OF E-MAIL ADDRESSEE

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/554,311

(22) Filed: Oct. 30, 2006

(51) Int. Cl. G06F 15/16

(52) U.S. Cl. 709/206

(57) ABSTRACT

A method, system and computer program product for providing an out-of-office notification reminder to a user composing and sending emails from an email account is presented. In particular, an Out-of-Office utility provides a notification reminder to an email sender if the sender composes an email to an out-of-office recipient from whom the sender had previously received an automated out-of-office reply. When an automated out-of-office reply is initially received by a sender, the Out-of-Office utility allows the email software to capture and store the out-of-office notification data (e.g., sender and recipient e-mail Identifiers (IDs), email recipient's out-of-office dates, and notification message). When the sender types in an e-mail ID while composing an email message, the e-mail program scans an up-to-date (current) file of previously received out-of-office information. If there is an email ID match, the e-mail software displays a pop-up window alerting and notifying the sender of the previously received message.

### RELATED APPLICATIONS

The present application is related to the subject matter of commonly assigned, co-pending patent application Ser. No. ______ (Atty. Doc. No. AUS920060832US1), titled “Automatically Transmitting E-mail to Specified Backup Address for Out-of-Office Recipient,” filed concurrently herewith. The content of the related application is incorporated herein by reference.

### BACKGROUND OF THE INVENTION

1. Technical Field

The present invention generally relates to computer systems and in particular to electronic mail (email) functions in computer systems. Still more particularly, the present invention relates to email notification functions in computer systems.

2. Description of the Related Art

Electronic mail (e-mail) is a widely utilized communication tool in the computer network environment. E-mail is an especially critical business tool for communication in large, geographically-distributed organizations. These large organizations are frequently challenged with keeping track of personnel who are available to work or respond to issues as the issues arise. These issues are oftentimes communicated from one person to the other within the organization via email and the recipient of the email is then expected to respond to or resolve the issue.

To help e-mail senders know which e-mail receivers are available to work or to respond to issues sent via e-mail, most e-mail systems contain an “out-of-office” notification function. This function alerts an e-mail sender if the recipient is not going to be checking e-mail for a specific period of time, perhaps due to an illness or a vacation, and often includes a return date or end date. Sending e-mail to a recipient who has enabled the out-of-office notification function triggers a return from the recipient's email system of a designated e-mail message/notification to the sender. This notification allows the sender to take other action. For example, if the sender's e-mail contains time sensitive information that must be handled before the recipient's return date, the sender is able to re-route the request to another person within the organization.

With the present out of office notification function, the sender often does not remember the recipient's return date or may not be given a return date, and the sender may periodically send an email to the recipient, only to receive a new out of office notification. This is particularly true when a recipient has set the out-of-office function for an extended period of time. If the sender has time-sensitive communication that must be addressed and there is a second or backup person (other then the out-of-office recipient) who is capable of responding to the sender's email request, the sender may lose valuable time through the redundant actions of resending and repeatedly receiving multiple out-of-office notifications before taking appropriate action.

The present invention appreciates the importance of a method to facilitate an out-of-office aware e-mail system that gives the sender the opportunity to reduce redundancy and increase efficiency while the sender carries out email messaging activities.

### SUMMARY OF THE INVENTION

Disclosed is a method, system and computer program product for providing an out-of-office notification reminder to a user composing and sending emails from an email account. In particular, an Out-of-Office utility provides a notification reminder to an email sender if the sender composes an email to an out-of-office recipient from whom the sender had previously received an automated out-of-office reply. When an automated out-of-office reply is initially received by the sender, the Out-of-Office utility allows the email software to capture and store the out-of-office notification data (e.g., recipient e-mail identifier (ID), email recipient's out-of-office dates, and specific out-of-office message). When the sender types in an e-mail ID while composing an email message, the e-mail program scans a file of previously received out-of-office information. If there is a match of the e-mail ID within the file, then the e-mail software displays a pop-up window alerting and notifying the sender of the previously received out-of-office notification message. The Out-of-Office utility also enables the e-mail software program to maintain a valid file of notification data by removing expired entries.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a data processing system, according to an illustrative embodiment of the invention;

FIG. 2 is a block diagram representation of a computer network, according to an illustrative embodiment of the invention;

FIG. 3 illustrates an example user interface of an email application during e-mail composition to an out-of-office recipient, according to an illustrative embodiment of the invention;

FIG. 4 illustrates the process completed by an e-mail notification system when executing the Out-of-Office utility, according to an illustrative embodiment of the invention; and

FIG. 5 illustrates an example screen capture of a graphical user interface (GUI) for activating an enhanced automated out-of-office message response, according to an illustrative embodiment of the invention.

### DETAILED DESCRIPTION OF AN ILLUSTRATIVE EMBODIMENT

The present invention provides a method, system and computer program product for providing an out-of-office notification reminder to a user composing and sending emails from an email account. In particular, an Out-of-Office utility provides a notification reminder to an email sender if the sender composes an email to an out-of-office recipient from whom the sender had previously received an automated out-of-office reply. When an automated out-of-office reply is initially received by the sender, the Out-of-Office utility allows the email software to capture and store the out-of-office notification data (e.g., recipient e-mail identifier (ID), email recipient's out-of-office dates, and specific out-of-office message). When the sender types in an e-mail ID while composing an email message, the e-mail program scans a file of previously received out-of-office information. If there is a match of the e-mail ID within the file, the e-mail software displays a pop-up window alerting and notifying the sender of the previously received out-of-office notification message. The Out-of-Office utility also enables the e-mail software program to maintain a valid file of notification data by removing expired entries.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

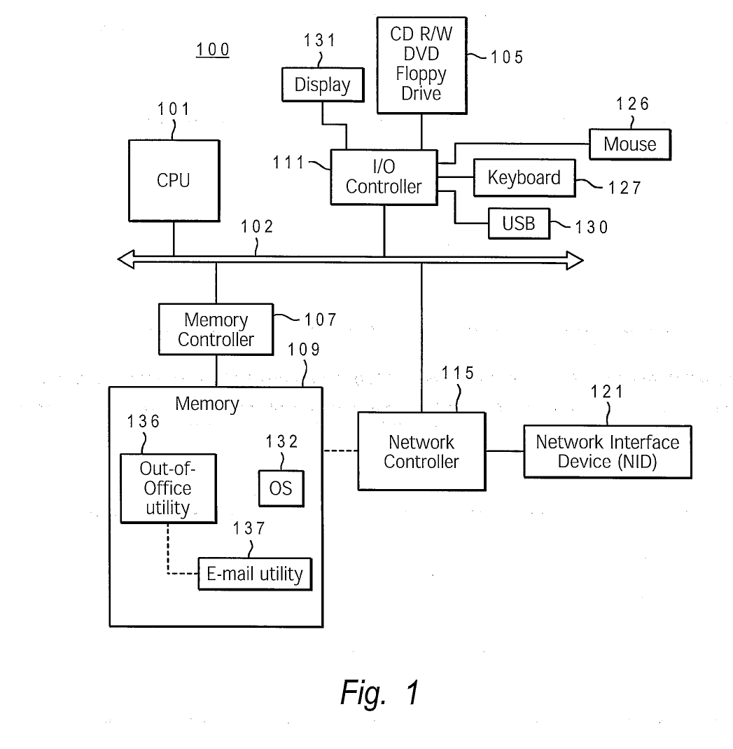

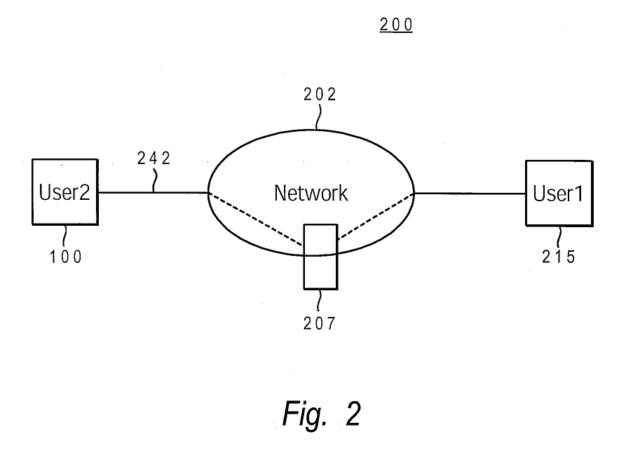

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

It is also understood that the use of specific parameter names are for example only and not meant to imply any limitations on the invention. The invention may thus be implemented with different nomenclature/terminology utilized to describe the above parameters, without limitation.

With reference now to the figures, FIG. 1 depicts a block diagram of a data processing system within which features of the invention may be advantageously implemented. Data processing system (DPS) 100 comprises central processing unit (CPU) 101 coupled to system bus/interconnect 102. Also coupled to system bus/interconnect 102 is memory controller 107 which controls access to memory 109. System bus 102 is also coupled to input/output controller (I/O Controller) 111, which controls access by several input devices, of which mouse 126 and keyboard 127 are illustrated. I/O Controller 111 also controls access to output devices, of which display 131 is illustrated. In order to support use of removable storage media, I/O Controller 111 may further support one or more USB ports 130 and one or more drives 105 for media, such as compact disk Read/Write (CDRW), digital video disk (DVD), and Floppy disk, for example.

DPS 100 further comprises network interface device (NID) 121 by which DPS 100 is able to connect to and communicate with an external device or network (such as the Internet). NID 121 may be a modem or network adapter and may also be a wireless transceiver device.

Those of ordinary skill in the art will appreciate that the hardware depicted in FIG. 1 may vary. For example, other peripheral devices, such as optical disk drives and the like, also may be used in addition to or in place of the hardware depicted. Thus, the depicted example is not meant to imply architectural limitations with respect to the present invention. The data processing system depicted in FIG. 1 may be, for example, an IBM eServer pSeries system, a product of International Business Machines Corporation in Armonk, N.Y. It should also be noted that while described as a data processing system throughout the description herein, the features of the invention are fully applicable to any type of device that enables email communication and/or similar functionality. The invention is thus fully applicable to hand held devices, such as Blackberry®, cell phones, personal digital assistants (PDAs) and other types of devices/machines that support email communication. Various features of the invention are provided as software code stored within memory 109 or other storage and executed by processor(s) 101. Among the software code are code for providing application server functionality, code for enabling network connection and communication via NID 121, and more specific to the invention, code for enabling the out-of-office notification features described below. For simplicity, the collective body of code that enables the out-of-office notification features is referred to herein as the Out-of-Office utility. In actual implementation, the Out-of-Office utility may be added as a subroutine to existing email software that enables an email engine to provide the out-of-office functionality described below.

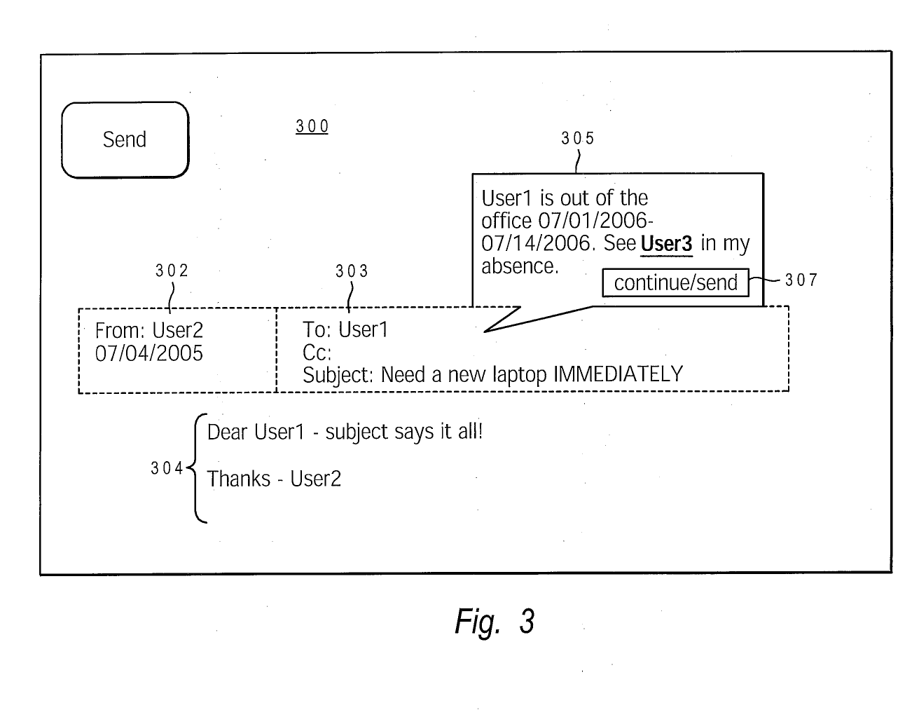

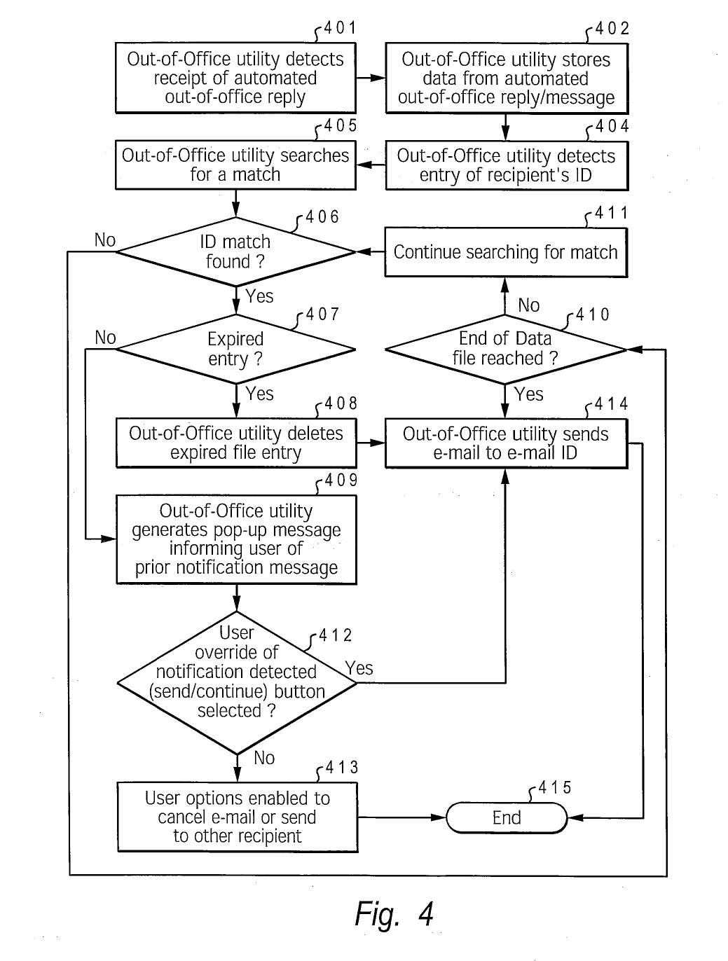

Thus, as shown by FIG. 1, in addition to the above described hardware components, data processing system 100 further comprises software components, including operating system (OS) 132 (e.g., the Advanced Interactive Executive (AIX) operating system, or Microsoft Windows®, a trademark of Microsoft Corp, or GNU®/Linux®, registered trademarks of the Free Software Foundation and The Linux Mark Institute) and one or more software applications, including Out-of-Office utility 136 and email utility 137. In implementation, OS 132, Out-of-Office utility 136, and email utility 137 are located within memory 109 and executed on processor (CPU) 101. According to the illustrative embodiment, when processor 101 executes Out-of-Office utility 136, Out-of-Office utility 136 enables data processing system 100 to complete a series of functional processes, including: (1) detecting an initial out-of-office notification received by the sender's email account; (2) capturing and storing the out-of-office notification data (e.g., e-mail ID of the recipient to which the original email that generated the out-of-office notification was sent, email recipient's out-of-office dates, and associated message transmitted with the out-of-office notification); (3) searching stored out-of-office notification data for potential matches during subsequent email addressing/composition; (4) displaying a pop-up window alerting and notifying the sender of the previously received out-of office notification, if a match is found; and (5) maintaining a file of valid notification data by automatically removing expired entries; and other features/functionality described below and illustrated by FIGS. 3-4.

FIG. 2 is a block diagram representing a computer network within which features of the invention may be advantageously implemented. In computer network 200, network 200 includes email server 207, which is utilized to provide the various out-of-office functional processes in one embodiment. DPS 100 is connected to Network 202 and ultimately to email server 207 via wired or wireless connection 242. Network 202 is also connected to DPS 215. DPS 100 and DPS 215 serve as user devices and provide access to email server 207 through network 202. According to the described embodiments, DPS 100 serves as the system on which a mail user engine (MUA) of the email sender (User2) operates, while DPS 215 serves as the system on which the MUA of the email recipient who is out of office (User1) operates.

Mail User Agent (MUA) messages (i.e., email messages) are typically structured according to a protocol known as Simple Mail Transfer Protocol (SMTP) which includes specification of an addressing format that enables email messages to be routed or directly delivered to the correct email server. SMTP is an application layer protocol usually used as part of a graphical user interface (GUI) application. Users may create email messages using applications such as Lotus Notes®, Netscape Messenger, or Microsoft Outlook®, and the application would then forward the message towards the message's destination using SMTP. The SMTP protocol is a means for transporting email messages from sending DPS 100 to email server 207. Email server 207 contains software implementing SMTP, which allows email server 207 to communicate with the email client, executing within DPS 100 and DPS 215. Common examples of such software include Microsoft Exchange Server and Netscape Messaging Server. Each message is temporarily stored on email server 207 until DPS 215, the recipient email client, connects to email server 207, and collects or “downloads” the email messages.

According to the described embodiment, a first user (referred to herein as the sender and identified by a specific sender email account (User2)) composes an email using email utility 137 residing on DPS 100 to send an email message to a recipient (identified by a specific recipient email account (User1)) using DPS 215 via Network 202. For example, network 202 may be the Internet. Whenever the recipient of the email message has the out-of-office function activated, the sender receives an automatically generated out-of-office notification once the email message arrives at email server 207 (or at recipient's DPS 215 for embodiments in which the out-of-office notification function is completed locally to the particular user's device). Out-of-Office utility 136 (either independently or in conjunction with email utility 137) stores the notification data in local storage.

As described above, the notification data may include one or more of the following: (1) sender e-mail ID; (2) recipient e-mail ID; (3) the email recipient's out-of-office dates; and (4) the email message. In one embodiment, the notification data may also include (4) the e-mail ID of an alternate or colleague who the recipient has selected to handle the duties of the recipient in the recipient's absence. In one embodiment, Out-of-Office utility 136 searches for matches to any subsequently-composed email messages by the sender addressed to the same recipient during the out-of-office period. If a match is found, Out-of-Office utility 136 generates a message box, which appears (pop up) on display 131 to remind the sender of the previous notification. Out-of-Office utility 136 also provides the ability and/or functionality to maintain a valid file of notification data by removing expired entries.

In one embodiment, Out-of-Office utility 136 may be packaged with email utility 137, forming an enhanced email application in which Out-of-Office utility 136 provides added features or functionality to email utility 137, according to the described embodiment. In another embodiment, Out-of-Office utility 136 may be packaged separately to email utility 137. In this alternate embodiment, Out-of-Office utility 136 may be regarded as a plug-in or an upgrade to email utility 137.

According to the described embodiment, a user (sender) composes an email using DPS 100 to send an email message to a recipient using DPS 215, via network 202. Whenever the recipient of the email message has the out-of-office function activated, the sender receives an automatically generated out-of-office notification once the email message arrives at email server 207 (or at the recipient's DPS 215). In a first embodiment, the entire secondary notification process (i.e., following the receipt by the sender of an initial out-of-office notification) occurs on the sender's local machine/device (e.g., DPS 100). Thus, the local email engine executing on the sender's machine/device is enhanced with the out-of-office utility and a small portion of the storage allocated to the email engine is (e.g., storage for storing email messages, appointments etc.) is allocated to maintaining a file/table of received out-of-office notification data. This file is occasionally purged to remove any notification that has expired (i.e., current date/time has passed the end date/time for the notification). Once the user enters the recipient's email address within any one of the address bars (e.g., To; cc; bc) (or prior to sending the email once the send button is selected by the sender), the utility checks the address (email ID) against those within the file and automatically issues the out-of-office notification before the user is able to send the email to the recipient. The sender may elect to still send the email, but is made aware that the intended recipient is not expected to receive and/or return the email until the end date/time.

In an alternate embodiment, the server is itself utilized to trigger the out-of-office function. This embodiment is most applicable to email engines that run on the server versus email engines that execute on and download emails to the user's local device. For example, Hotmail® and Yahoo® provides server-level email engines accessible via the Internet. With such systems, the out-of-office functionality is maintained at the server level and the notification data is stored at the server level a well. In contrast, Microsoft Outlook® provides a local device-level email engine, and the out-of-office functionality is maintained at the user's local device.

Regardless of the specific implementation (user device level versus server level), the functionality is tied to the user's email account and account ID and not to the device utilized to access the email account. Thus, either embodiment works the same from the perspective of the user (sender). Once the sender receives an out-of-office notification, the sender may then take action according to the content of the automated out-of-office message. For example, the message may suggest that the sender directs e-mails to another recipient during the out-of-office period.

FIG. 3 illustrates a user interface (e.g., a graphical user interface) of an example email application during e-mail composition, according to the described embodiment. Email interface 300 illustrates an e-mail that is being composed by User2 (the sender) to be sent to User1 (intended recipient). Email interface 300 depicts sender data 302, which includes the e-mail ID of the sender (User2) and the date of the e-mail composition. Email interface 300 also depicts recipient data 303, which includes the e-mail ID of the intended recipient (User1) and the subject of the e-mail. Additionally, email interface 300 depicts message 304 and notification reminder 305. Within notification reminder 305 is a selection “button,” continue/send button 307, which enables the user to override the notification reminder and still send the email to the intended recipient (User1). Additionally, the backup email ID (User3) may be provided as a selectable link (illustrated via the underlined format), which populates User3 address within the address bar in lieu of, or in addition to, the User1 address.

As represented by notification reminder 305 in the FIG. 3 example, User1 (the recipient) has activated the out-of-office notification indicating that User1 will not be checking or responding to e-mail from Jul. 1, 2006 to Jul. 14, 2006. When User2 sends an initial e-mail to User1 during the out-of-office period, User2 receives an initial out-of-office notification, which may direct User2 to contact User3. If User2 subsequently fails to remember the message or the precise out-of-office period for User1 and User2 later generates an e-mail to send to User1 during the notification period, notification reminder 305 is automatically generated to again inform (or remind) User2 of the previously-received out-of-office notification and message. In the illustrative embodiment, that message includes a backup email address of the person to contact during the period in which the originally intended recipient (User1) is out of office.

In one embodiment, described in greater detail in the related application, the out-of-office utility may include the functionality to automatically populate the address bar of an email composition to the recipient with the email ID of User3. In a first implementation, the automatic inclusion of a User3 email ID is triggered by detecting such a User3 email ID within the body of the notification message. Accordingly, the out-of-office utility parses the body (i.e., the message component, as opposed to the addressing component or the signature component) of the out-of-office email notification for any text in email format, i.e. <User3>@<domain> format. Such email addresses found specifically within the body may then be presented automatically as an option when the new email is being composed and addressed to User2.

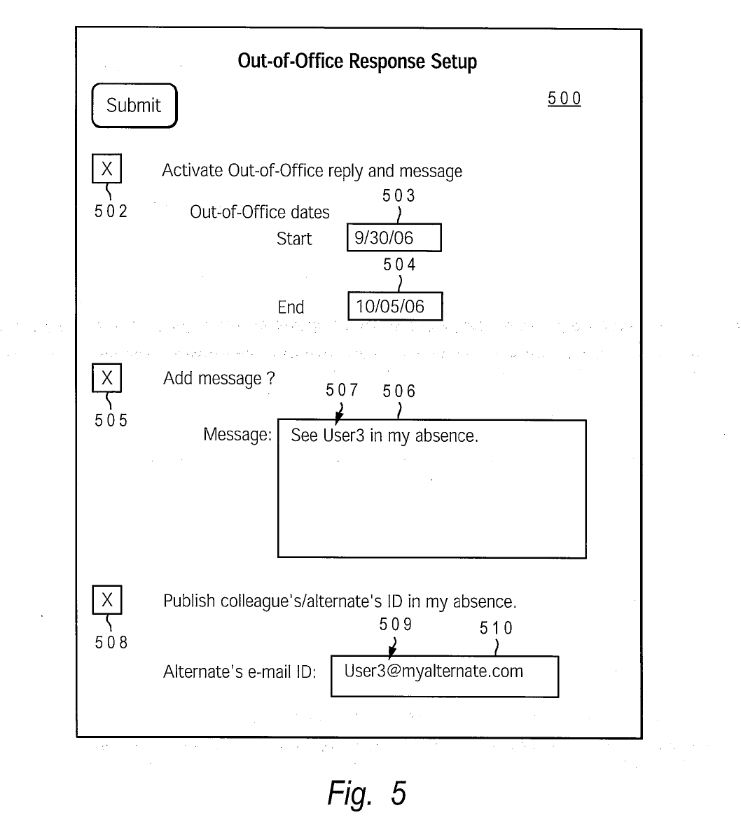

In another embodiment, this automatic inclusion of User3's email ID within any one of the address bars (e.g., to:, cc:) may alternatively be triggered because of an enhancement to an Out-of-Office Notification Activation/Setup GUI (FIG. 5), which may exist as a part of Out-of-Office utility 136. This enhancement allows the sender to efficiently re-direct emails to User3. With this embodiment, no parsing for email IDs is required as the email ID of the alternate/backup person is already provided within a pre-established location of the out-of-office notification (or notification message).

FIG. 5 illustrates an example out-of-office notification activation (ONA) graphical user interface (GUI) for activating an automated out-of-office message response along with a backup email ID for the sender to forward email communication during the out-of-office period. The automated out-of-office response activation system is enhanced by Out-of-Office utility 136 to allow the user to enter the email ID of an alternate/colleague to whom emails may be directed during the user's absence. ONA GUI 500 comprises notification setup check box 502, message inclusion check box 505 and alternate email check box 508. ONA GUI 500 also comprises start date field 503, end date field 504, and message box 506. Message box 506 contains message 507. Additionally, ONA GUI 500 comprises alternateID field 510.

In ONA GUI 500, a user (potential email recipient) activates an out-of-office message response by placing a check mark in notification setup checkbox 502. The user then sets/defines the out-of-office period by entering the start date and the end date of the out-of-office period in start date field 503 and end date field 504, respectively. The user selects to add a message to the out-of-office reply by placing a check mark in checkbox 505. Placing a check mark in checkbox 505 gives the user access to message box 506, in which the user types message 507. ONA GUI 500 also provides a mechanism to publish the email ID of the user's colleague/alternate to whom email messages may be directed during the user's absence, i.e., during the out-of-office period. This alternate ID represents the user's backup recipient when the same sender later generates an e-mail message addressed to the user, as described herein. Specifically, by placing a check mark in alternate ID checkbox 508 the user is granted access to alternate ID field 510 (a text box) in which the user enters alternateID 509.

In an advanced implementation, the user may also be provide the option of enabling subsequent email being generated by the same sender to override the email address of the user and replace it with that of the alternateID 509. This enables the user to not receive a clutter of messages in the user's inbox, while the user is on vacation (or away for whatever reason), particularly when the messages have already been received and responded to by the user's designated backup recipient.

In order to take advantage of the enhancements provided in ONA GUI 500 by Out-of-Office utility 136, the following actions occur: (1) the designation of a colleague/alternate responder to emails by entry of the colleague's email ID during activation/setup of the automated out-of-office reply by a user (email recipient); and (2) the automatic inclusion of the colleague's email ID within one of the address bars (e.g., to:, cc:) during a subsequent email composition (by a sender) to the user that triggers a display of an out-of-office reminder notification to the sender. In one embodiment, the colleague's email ID is highlighted within the address bar to alert the user to the automatic inclusion of the alternate/backup email ID. Highlighting the colleague's email ID makes the sender aware of that the email is also being sent to the alternate/backup email address and enables the sender to decide whether to remove the backup email address or take other actions, such as modifying the content of the email.

Not remembering the message or the out-of-office period is just one example of a reason why User2 may begin composing another email to User1 during the out-of-office period. User2 may also wish to take advantage of the functionality of Out-of-Office utility 136 to quickly and efficiently retrieve the essence of the previous notification message. Thus, User2 may utilize the reminder in one or more of the following ways: (1) User2 may wish to retrieve User3's email ID in order to contact User3, as suggested in the e-mail message; (2) User2 may wish to recall User1 's return date; (3) User2 may have completely forgotten the content of the message; and/or (4) User2 may be pleasantly surprised to see that User2's email software came with notification reminder 305 affording User2 the opportunity to efficiently redirect emails to User3 (or take alternative action) and avoid redundant e-mail activity.

FIG. 4 illustrates the process completed by the email notification system when executing Out-of-Office utility 136 along with email utility 137, according to the described embodiment. The process begins at block 401, at which Out-of-Office utility 136 detects the receipt of an automated out-of-office reply. The automated out-of-office reply is received by a user (sender) when the recipient (of sender's email) has activated the out-of-office email reply feature. Out-of-Office utility 136 stores the data from the automated out-of-office reply, as shown at block 402. At block 404, Out-of-Office utility 136 detects the entry of an intended recipient's ID during email composition. Out-of-Office utility 136 then searches, as shown at block 405, for an identical match of the intended recipient's ID in the file of notification data. At block 406, Out-of-Office utility 136 determines whether an ID match is found. If no match is found, Out-of-Office utility 136 determines, at block 410, whether the search for a match has reached the end of the data file. If the end of the data file has not been reached, Out-of-Office utility 136 continues searching the file for a valid match, as shown at block 411. Following block 411, the process returns to block 406. If the end of the data file is reached and no match is found, the sender continues to compose and send the email as usual (block 414), with no notification reminder from Out-of-Office utility 136. The process moves to block 415 where the process ends.

However, if Out-of-Office utility 136 finds a match, Out-of-Office utility 136 determines, as shown at block 407, whether the entry in the file of notification data is still valid (or has expired). Expired entries are found by comparing the out-of-office period (specifically, the period's closing date) with the current date. If the current date is later than the closing date of the out-of-office period, the entry is considered expired. When expired notifications (entries) are found, these expired entries are deleted, as shown at block 408. If (at block 407) Out-of-Office determines that the matching entry is valid or current, Out-of-Office utility 136 generates a (pop-up) reminder message, as shown at block 409. This reminder message (305) is displayed within email GUI 300 on display 131, and again informs the sender of the previous notification and associated message. In one embodiment, the reminder message 305 is generated proximate to the time the recipient address is entered. In an alternate embodiment, the reminder message 305 is generated when the sender selects the send option for the email. The sender is then reminded of the status to the recipient prior to the email engine completing the transmission of the email.

Returning to the figure, Out-of-office 136 utility then determines at block 412 if a sender override of the reminder notification is detected. Detection of the sender override may be as a result of a user action from among: (a) selecting the send/continue button within the reminder message (305); (b) selecting the send button on the email GUI 300; (c) closing the reminder message pop-up, which automatically activates the send option; among others. If the user override is detected (perhaps within a time-out period), out-of-office utility 136 enables email engine to transmit the email to the email ID(s) initially entered by the user, as shown at block 414. The process then proceeds to block 415 at which the process ends. In one embodiment, the notification (305) is removed after a pre-established time has elapsed to enable the user to proceed with/return to composing and/or addressing and/or sending the email, when no subsequent send selection is detected.

Returning to block 412, if the user override is not detected, indicating that the user intends to make some adjustment to the recipient addresses, the out-of-office utility facilitates the entry of the backup recipient's address and other user selectable addressing and emailing options, as shown at block 413. One possible option is for the user to replace the original (out-of-office) recipient's address with the backup recipient address. Another option is for the sender/user to add the backup recipient's address along with the original recipient's address. In one embodiment, either option may be facilitated by the selection of the backup recipient address (User3) within the reminder message 305, where the selection automatically populates the address field with the backup recipient address. Yet another option is for the sender to cancel the email completely, where the sender only wishes to send the email to the out-of-office recipient and may decide to wait until the out-of-office recipient returns. Once the sender has made the required changes and the out-of office utility detects the selection of the send button of email GUI 300, the email engine is triggered to send the email to the email IDs within the address field, as shown at block 414.

In the flow chart (FIG. 4) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims. In particular, while the steps of parsing the notification message for the alternate email ID are illustrated and described as occurring at the point when the reminder message is being outputted, the parsing of the notification message may occur at the time the message is first received from the recipient. The alternate email ID is then stored along with the notification data and automatically populated into the address field of the new email being composed to the recipient.

In the described embodiment, an Out-of-Office utility responding to out-of-office replies or notifications is presented. However, the invention may be used to respond to other types of notifications. Use of a particular nomenclature or type of notification in describing the invention is not meant to imply any limitations on the invention.

The Out-of-Office utility provides added functionality to email software by providing notification reminders which allow an email sender to experience increased efficiency by reducing the transmission of redundant emails to an out-of-office recipient and by providing a facility to quickly retrieve calendaring and other information regarding previously received out-of-office email messages. The Out-of-Office utility also provides the ability to automatically populate the address field, during email composition by the sender, with a backup email address of a backup recipient specifically identified by the out-of-office recipient.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
recording a receipt of a notification from a first electronic address, said notification received in response to a first electronic communication from a sender electronic address to the first electronic address;
during subsequent composition of a new electronic communication, comparing a target electronic address of each addressee with the first electronic address; and
when the target electronic address matches the first electronic address, automatically outputting a notification reminder, which serves as a reminder of the previous receipt of the notification when the first electronic communication was sent to that target electronic address.

2. The method of claim 1, wherein:
said recording the receipt of the notification further includes storing, within a notification list, the content of the notification along with the first electronic address associated therewith;
said comparing the target electronic address includes:
first detecting entry of the target electronic address within an address field of the new electronic communication being composed; and
comparing the target electronic address against one or more stored electronic address within the notification list; and
said automatically outputting the notification reminder includes:
determining that the target electronic address matches an electronic address among the one or more stored electronic address within the notification list; and
displaying the content stored along with and associated with the electronic address to provide information about the notification in addition to the reminder of the previous receipt of the notification.

3. The method of claim 2, wherein:
said storing the content of the notification further includes parsing the content of the notification for a validity period, which indicates a period of time during which the notification is valid and during which the notification reminder should be displayed;
storing the validity period along with remaining content of the notification; and
said automatically outputting further comprises:
first checking whether the validity period of the notification has expired;
performing said automatic outputting of the notification reminder only when the validity period is not expired; and
when the validity period is expired, deleting the information corresponding to said notification from the notification list and withholding the automatic outputting of the notification reminder.

4. The method of claim 1, wherein said automatically outputting further comprises:
displaying the notification reminder within a pop-up window;
displaying a send continue selection option within the pop-up window; and
enabling an override of the notification reminder, which override enables automatic closing of the notification reminder pop-up window and transmission of the email to the first electronic address.

5. The method of claim 4, further comprising:
enabling selection of a non-override of the notification reminder, which enables a return of an editing cursor to the address field of the email being composed for further editing of recipient addresses within the address field prior to transmitting the email.

6. The method of claim 1, wherein said notification is an out-of-office notification, said method further comprising:
enabling opening of a out-of-office notification activation (ONA) graphical user interface (GUI); and
displaying within the ONA GUI a plurality of selectable options, including setup of an out-of-office notification, entry of a notification message, and entry of the validity period in which the notification is valid.

7. The method of claim 1, wherein the electronic communication is an electronic-mail (e-mail) and the electronic address is an e-mail address.

8. A system comprising:
a processor;
an electronic communication engine that enables transmitting and receiving electronic messages using electronic addresses;
a utility associated with the electronic communication engine having program means for performing the functions of:
recording a receipt of a notification from a first electronic address, said notification received in response to a first electronic communication from a sender electronic address to the first electronic address;
during subsequent composition of a new electronic communication, comparing a target electronic address of each addressee with the first electronic address; and
when the target electronic address matches the first electronic address, automatically outputting a notification reminder, which serves as a reminder of the previous receipt of the notification when the first electronic communication was sent to that target electronic address.

9. The system of claim 8, further comprising a storage device, wherein:
said program means for recording the receipt of the notification further includes means for storing, within a notification list, the content of the notification along with the first electronic address associated therewith;
said program means for comparing the target electronic address includes:
means for first detecting entry of the target electronic address within an address field of the new electronic communication being composed; and
means for comparing the target electronic address against one or more stored electronic address within the notification list; and
said automatically outputting the notification reminder includes:
means for determining that the target electronic address matches an electronic address among the one or more stored electronic address within the notification list; and
means for displaying the content stored along with and associated with the electronic address to provide information about the notification in addition to the reminder of the previous receipt of the notification.

10. The system of claim 9, wherein:
said program means for recording the receipt of the notification further includes:
means for said storing the content of the notification further includes parsing the content of the notification for a validity period, which indicates a period of time during which the notification is valid and during which the notification reminder should be displayed; and
means for storing the validity period along with remaining content of the notification; and
said program means for automatically outputting further comprises:
means for first checking whether the validity period of the notification has expired;
means for performing said automatic outputting of the notification reminder only when the validity period is not expired; and
means for deleting the information corresponding to said notification from the notification list and withholding the automatic outputting of the notification reminder, when the validity period is expired.

11. The system of claim 8, wherein said program means for automatically outputting further comprises:
means for displaying the notification reminder within a pop-up window;
means for displaying a send continue selection option within the pop-up window;
means for enabling an override of the notification reminder, which override enables automatic closing of the notification reminder pop-up window and transmission of the email to the first electronic address; and
means for enabling selection of a non-override of the notification reminder, which enables a return of an editing cursor to the address field of the email being composed for further editing of recipient addresses within the address field prior to transmitting the email.

12. The system of claim 8, wherein said notification is an out-of-office notification, said utility further comprising:
means for enabling opening of a out-of-office notification activation (ONA) graphical user interface (GUI); and
means for displaying within the ONA GUI a plurality of selectable options, including setup of an out-of-office notification, entry of a notification message, and entry of the validity period in which the notification is valid.

13. The system of claim 8, wherein the electronic communication engine is a Mail User Agent, the electronic communication is an electronic-mail (e-mail) and the electronic address is an e-mail address.

14. A computer program product comprising:
a computer readable medium; and
program instructions on the computer readable medium that when executed performs the functions of:
recording a receipt of a notification from a first electronic address, said notification received in response to a first electronic communication from a sender electronic address to the first electronic address;
during subsequent composition of a new electronic communication, comparing a target electronic address of each addressee with the first electronic address; and
when the target electronic address matches the first electronic address, automatically outputting a notification reminder, which serves as a reminder of the previous receipt of the notification when the first electronic communication was sent to that target electronic address.

15. The computer program product of claim 14, wherein:
said program instructions for recording the receipt of the notification further includes instructions for storing, within a notification list, the content of the notification along with the first electronic address associated therewith;
said program instructions for comparing the target electronic address includes instructions for:
first detecting entry of the target electronic address within an address field of the new electronic communication being composed; and
comparing the target electronic address against one or more stored electronic address within the notification list; and
said automatically outputting the notification reminder includes:
determining that the target electronic address matches an electronic address among the one or more stored electronic address within the notification list; and
displaying the content stored along with and associated with the electronic address to provide information about the notification in addition to the reminder of the previous receipt of the notification.

16. The computer program product of claim 15, wherein:
said program instructions for storing the content of the notification further includes instructions for:
parsing the content of the notification for a validity period, which indicates a period of time during which the notification is valid and during which the notification reminder should be displayed; and
storing the validity period along with remaining content of the notification; and
said program instructions for automatically outputting further comprises instructions for:
first checking whether the validity period of the notification has expired;
performing said automatic outputting of the notification reminder only when the validity period is not expired; and
deleting the information corresponding to said notification from the notification list and withholding the automatic outputting of the notification reminder, when the validity period is expired.

17. The computer program product of claim 14, wherein said program instruction for automatically outputting further comprises instructions for:
displaying the notification reminder within a pop-up window;
displaying a send continue selection option within the pop-up window;
enabling an override of the notification reminder, which override enables automatic closing of the notification reminder pop-up window and transmission of the email to the first electronic address; and
enabling selection of a non-override of the notification reminder, which enables a return of an editing cursor to the address field of the email being composed for further editing of recipient addresses within the address field prior to transmitting the email.

18. The computer program product of claim 14, wherein said notification is an out-of-office notification, said program instructions further comprising instructions for:
enabling opening of a out-of-office notification activation (ONA) graphical user interface (GUI); and
means for displaying within the ONA GUI a plurality of selectable options, including setup of an out-of-office notification, entry of a notification message, and entry of the validity period in which the notification is valid.

19. The computer program product of claim 14, wherein the electronic communication is an electronic-mail (e-mail) and the electronic address is an e-mail address.
